(19) United States
(12) Patent Application Publication
(10) Pub. No.: US 2008/0264379 A1
(43) Pub. Date: Oct. 30, 2008

(54) Rotary Engine

(76) Inventor: Hyuk-Jae Maeng, Kyungki-do (KR)

Correspondence Address: COOPER & DUNHAM, LLP, 1185 AVENUE OF THE AMERICAS, NEW YORK, NY, 10036, US

(21) Appl. No.: 11/884,670

(22) PCT Filed: Mar. 14, 2006
(86) PCT No.: PCT/KR06/00904

§ 371 Date: Aug. 17, 2007

(30) Foreign Application Priority Data
Mar. 14, 2005 (KR) 10-2005-0020840

(51) Int. Cl. F02B 53/00

(52) U.S. Cl. 123/212; 123/214

(57) ABSTRACT

A rotary engine is disclosed. The rotary engine of the present invention includes an engine body (100), which has therein a compression chamber (101), an output chamber (105) and a combustion chamber (109, 115), which is formed between the compression chamber and the output chamber. The rotary engine further includes a compression rotor (400) which is eccentrically provided in the compression chamber, an ignition device (125, 126) which is provided in the combustion chamber of the engine body, and an output rotor (500), which is eccentrically provided in the output chamber. The rotary engine further includes valves (600) which are provided in the respective bores of the combustion chamber, a synchronizing means for rotating the compression rotor in conjunction with rotation of the output rotor, and an axial sealing means for sealing the compression chamber, the combustion chamber and the output chamber.

### TECHNICAL FIELD

The present invention relates, in general, to rotary engines and, more particularly, to a rotary engine which prevents the loss of kinetic energy occurring in engines using reciprocating pistons or propellers, thus maximizing the thermal efficiency of the engine.

### BACKGROUND ART

Conventional reciprocating piston engines, in which compression, combustion and expansion strokes are conducted in a single cylinder, are disadvantageous in that excessive kinetic energy loss is incurred by reciprocating motion of the piston, high-speed rotation is difficult, and output power is low compared to the size of the engine. Gas turbine engines and wankel engines, which are kinds of rotary engines, are representative examples of engines which were developed to overcome the disadvantages of the reciprocating piston engines. Typically, the conventional gas turbine engines consist of three parts: a compressor, a combustion chamber, and a turbine, and have a structure in which, after the compressor compresses drawn air, the compressed air is mixed with fuel and burned in the combustion chamber, thus generating expansion energy for operating the turbine. Such a gas turbine engine has the advantage of realizing high-speed rotation. However, the gas turbine engine has a structure in which output power is generated by high-speed current striking the turbine, but the pressure of combustion gas is not directly converted into output power. Therefore, the gas turbine engine has a disadvantage of having low thermal efficiency. Meanwhile, conventional wankel engines include a housing having a cocoon shape or an elliptical shape, and a triangular rotor, which is provided in the housing and eccentrically rotates so that an intake process, a compression process and a combustion process are conducted in the single housing. Such a wankel engine is advantageous in that lightness of a product and smooth rotation are realized thanks to a simple structure. However, there are disadvantages in that the structure thereof makes complete combustion impossible, and a fuel consumption ratio is very low due to high heat loss.

### DISCLOSURE OF INVENTION

Technical Problem

Accordingly, the present invention has been made keeping in mind the above problems occurring in the prior art, and an object of the present invention is to provide a rotary engine which has a structure such that complete combustion of fuel is realized and explosive combustion power is transmitted to an output shaft without loss, thus maximizing the efficiency of the engine.

Another object of the present invention is to provide a rotary engine which minimizes vibration and noise.

A further object of the present invention is to provide a rotary engine which minimizes automobile exhaust fumes, which are principal factors of air pollution.

Yet another object of the present invention is to provide a rotary engine which minimizes pressure leakage.

Technical Solution

In order to accomplish the above object(s), the present invention provides a rotary engine, comprising: an engine body, having a cylindrical compression chamber having at a predetermined position thereof an intake hole, through which fuel/air mixture or air is drawn into the compression chamber, an output chamber formed through the engine body in a direction parallel to the compression chamber and having at a predetermined position thereof a discharge hole, through which combustion gas is discharged, and a combustion chamber formed between the compression chamber and the output chamber in a direction parallel both to the compression chamber and to the output chamber and divided into two cylindrical bores, which are symmetrical to each other, and each of which communicates with the compression chamber through an intake gate and communicates with the output chamber through a discharge gate; a compression rotor eccentrically provided in the compression chamber of the engine body and rotating such that fuel/air mixture or air is drawn into the compression chamber through the intake hole, compressed, and supplied into the combustion chamber through the intake gates; an ignition device provided in the combustion chamber of the engine body to ignite and explode the mixture or air compressed and supplied by the compression rotor; an output rotor eccentrically provided in the output chamber of the engine body and rotated using propulsive force generated by the combustion gas supplied from the compression chamber through the discharge gates; valves, provided in respective bores of the combustion chamber and controlling the intake gates and the discharge gates such that a compression process, a combustion process and an output process are sequentially conducted depending on rotational positions of the compression rotor and the output rotor; a synchronizing means to rotate the compression rotor in conjunction with rotation of the output rotor; and an axial sealing means for sealing the compression chamber, the combustion chamber and the output chamber of the engine body.

The compression rotor may include: a rotor shaft disposed at an eccentric position towards the output chamber relative to a central axis of the compression chamber; a sliding vane crossing a central axis of the rotor shaft and disposed so as to be slidable in a radial direction of the rotor shaft, the sliding vane having a width such that opposite side ends of the sliding vane diametrically contact an inner surface of the compression chamber, with a sealing member, having elasticity in a radial direction, provided on each of the side ends of the sliding vane which contact the inner surface of the compression chamber; a plurality of intake hole sealing pieces axially provided on a cylindrical surface, which is coaxial with the rotor shaft and has a diameter less than the width of the sliding vane, each intake hole sealing piece having radial and axial elasticity; and a spacer provided between adjacent intake hole sealing pieces such that the intake hole sealing pieces maintain a predetermined distance therebetween.

The output rotor may include: a rotor shaft disposed at an eccentric position towards the compression chamber relative to a central axis of the output chamber; a sliding vane crossing a central axis of the rotor shaft and disposed so as to be slidable in a radial direction of the rotor shaft, the sliding vane having a width such that opposite side ends of the sliding vane diametrically contact an inner surface of the output chamber, with a sealing member, having elasticity in a radial direction, provided on each of the side ends of the sliding vane which contact the inner surface of the output chamber; a plurality of intake hole sealing pieces axially provided on a cylindrical surface, which is coaxial with the rotor shaft and has a diameter less than the width of the sliding vane, each intake hole sealing piece having radial and axial elasticity; and a spacer provided between adjacent intake hole sealing pieces such that the intake hole sealing pieces maintain a predetermined distance therebetween.

Furthermore, each of the valves may include: a cylindrical valve body having a predetermined outer diameter such that an outer surface of the valve body contacts an inner surface of the related bore of the combustion chamber, with a passage formed through the valve body so that, when the valve body is rotated, the passage selectively communicates with the intake gate or with the discharge gate, and with the ignition device inserted into the valve body at a position opposite the passage; a valve shaft longitudinally extending from a predetermined position of the valve body; valve arms symmetrically provided on an end of the valve shaft in diametrically opposite directions and a roller provided on an end of each of the valve arms. The rotary engine may further comprise: main cams symmetrically provided on respective opposite ends of the rotor shaft of the output rotor at positions corresponding to the related rollers of the valves, so that the rollers ride the respective main cams, rotations of the valve bodies thereby being controlled by the related main cams every cycle of the output rotor such that the rotations of the valve bodies correspond to a rotational angle of the sliding vane of the output rotor; and subsidiary cams symmetrically provided on respective opposite ends of the rotor shaft of the compression rotor at positions corresponding to the remaining rollers of the valves, the subsidiary cams guiding the rollers related to the compression rotor, such that the rollers related to the compression rotor and the rollers related to the output rotor are point-symmetrical with respect to a central axis of the valve shaft.

The main cams of the output rotor and the subsidiary cams of the compression rotor may be configured such that compression process sections, explosion process sections and output process sections, in which the valve bodies maintain orientations thereof for a predetermined time without rotation, are defined, and the main cams and the subsidiary cams may be oriented such that, while the main cam provided on an end of the output rotor and the related subsidiary cam provided on an end of the compression rotor are in the output process sections for a predetermined time, the main cam provided on a remaining end of the output rotor and the related subsidiary cam provided on a remaining end of the compression rotor are maintained in the compression process sections and the explosion process sections, thus a time of ignition is controllable within the explosion process sections, which continues for the predetermined time, depending on revolution speed of the engine, thereby realizing complete combustion of fuel.

In the case that gas to be supplied into the compression chamber through the intake hole is fuel/air mixture, an ignition plug is used as the ignition device, and, in the case that the gas is air, a fuel injector is used as the ignition device.

The synchronizing means may include: an output rotor gear provided on an end of the rotor shaft of the output rotor; a compression rotor gear provided on an end of the rotor shaft of the compression rotor; and a medial gear connecting the compression rotor gear to the output rotor gear such that the compression rotor gear and the output rotor gear rotate in the same direction at a ratio of 1:1.

The axial sealing means may include: two covers, each having bearing seats at predetermined positions corresponding both to the rotor shafts of the compression rotor and the output rotor and to the valve shaft of each of the valves to support the rotor shafts and the valve shafts, the two covers being coupled to respective opposite ends of the engine body to seal open ends of the compression chamber, the combustion chamber, and the output chamber; and cover sealing plates, having axial elasticity, provided on opposite ends of the spacers of both the compression rotor and the output rotor and being in close contact with inner surfaces of the respective covers.

### Advantageous Effects

In a rotary engine of the present invention, complete combustion of fuel is realized, and explosive combustion power is transmitted to an output shaft without power loss, thus maximizing the efficiency of the engine. As well, the rotary engine of the present invention makes it possible to minimize vibration, noise and pressure leakage. Furthermore, because complete combustion is realized, there is an advantage in that automobile exhaust fumes, which are principal factors of air pollution, are minimized.

### BRIEF DESCRIPTION OF THE DRAWINGS

FIG. 1 is an exploded perspective view of a rotary engine, according to an embodiment of the present invention;

FIG. 2 is a perspective view of an engine body of the rotary engine according to the present invention;

FIG. 3 is a sectional view taken along the line A-A′ of FIG. 2;

FIG. 4 is a sectional view taken along the line B-B′ of FIG. 2;

FIG. 5 is a perspective view showing a compression rotor of the rotary engine according to the present invention;

FIG. 6 is a perspective view showing an output rotor of the rotary engine according to the present invention;

FIG. 7 is a perspective view showing a valve of the rotary engine according to the present invention;

FIG. 8 is a front view showing a valve of the rotary engine according to the present invention;

FIG. 9 is a partially broken perspective view showing a valve body of the valve of FIG. 7;

FIG. 10 is an assembled perspective view showing a main shaft (power transmission shaft) side of the rotary engine according to the present invention;

FIG. 11 is a front view showing the rotary engine of FIG. 10;

FIG. 12 is an assembled perspective view showing the opposite side of FIG. 10; and

FIGS. 13 through 33 are sectional views showing the operation of the rotary engine of the present invention in stages.

### BEST MODE FOR CARRYING OUT THE INVENTION

Hereinafter, a rotary engine according to a preferred embodiment of the present invention will be described in detail with reference to the attached drawings.

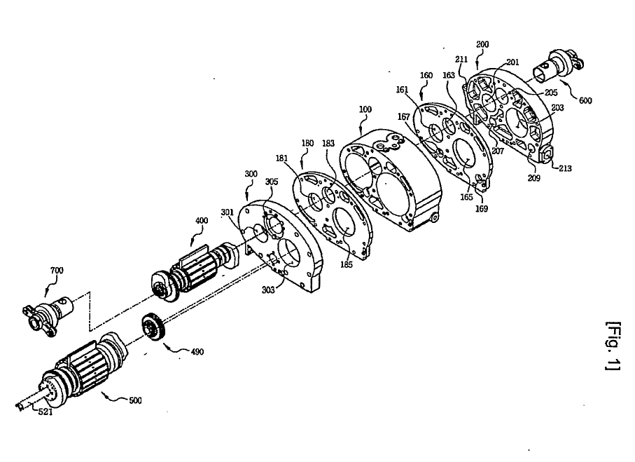

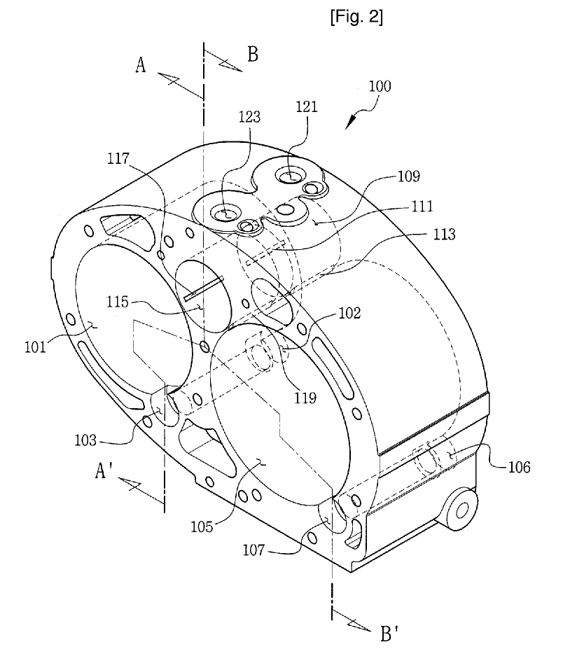

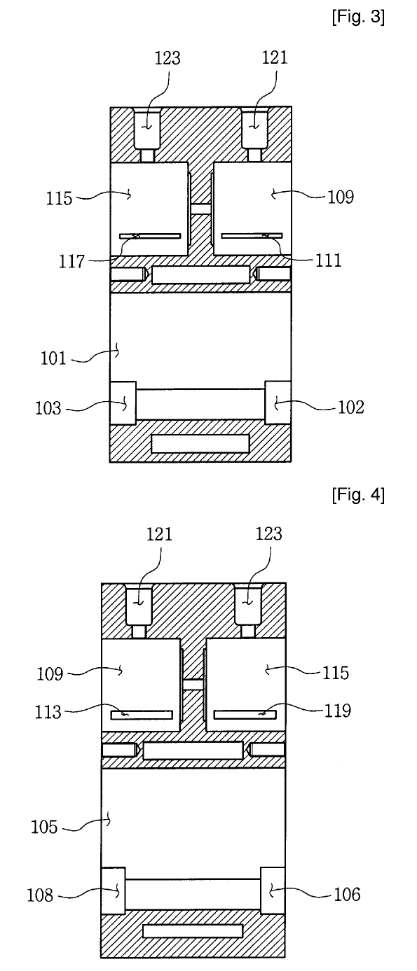

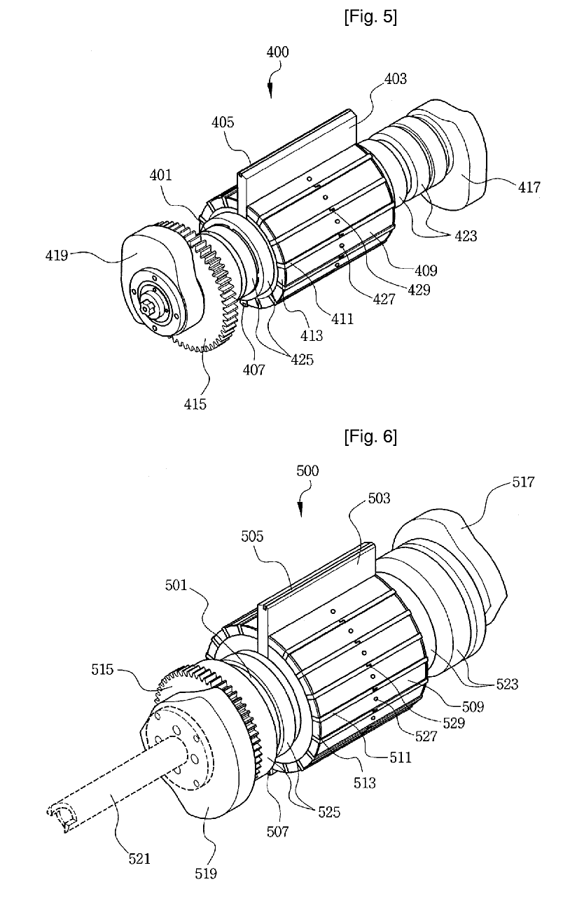

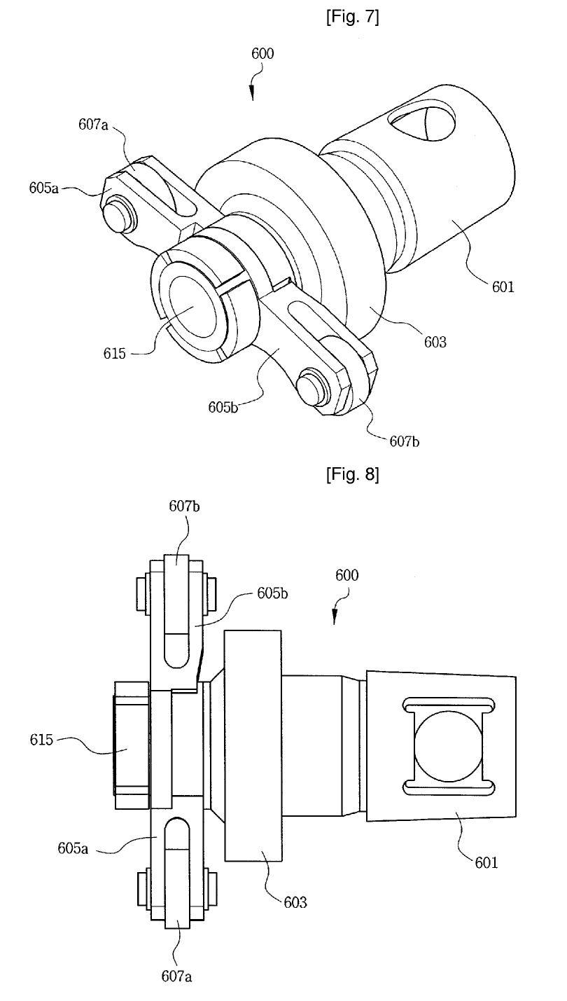

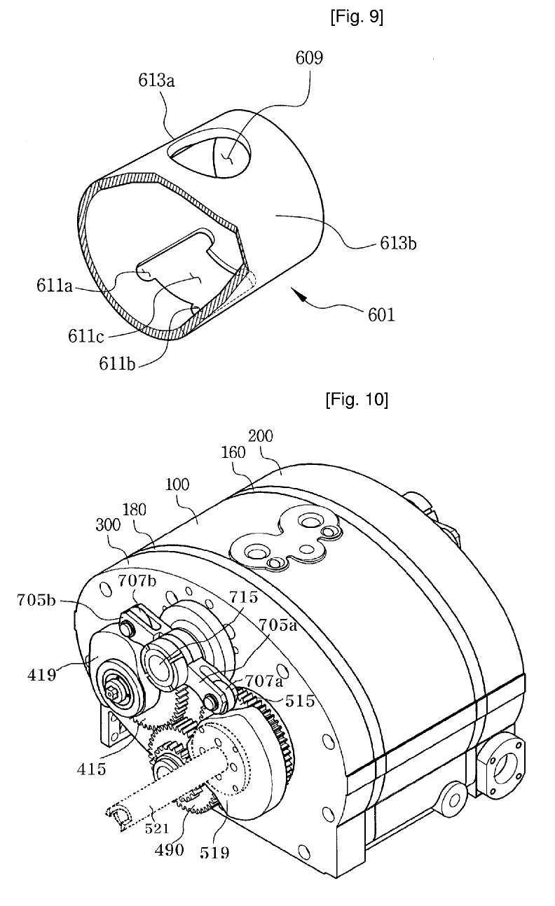

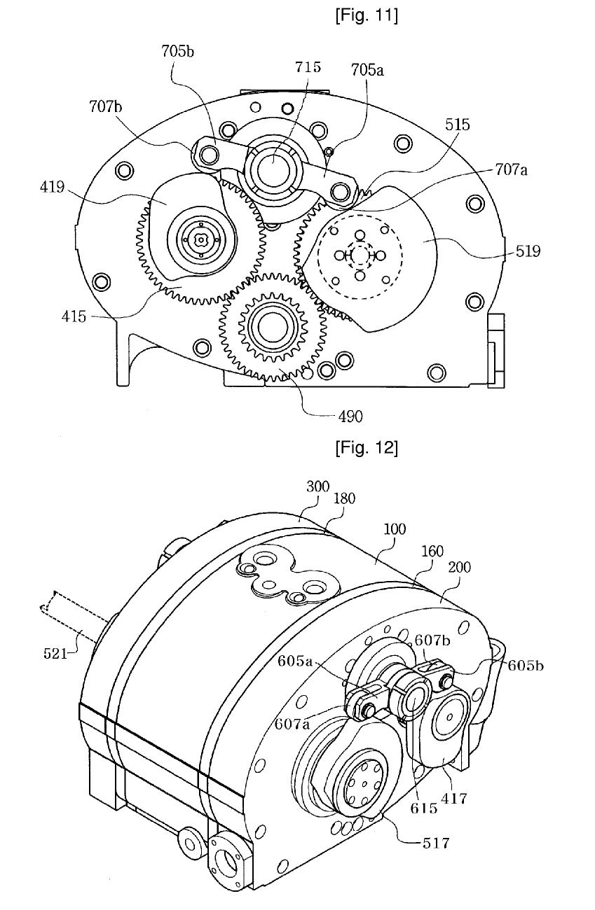

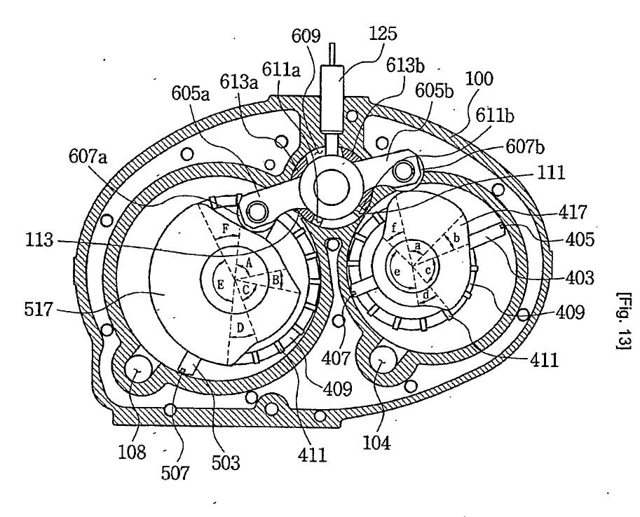

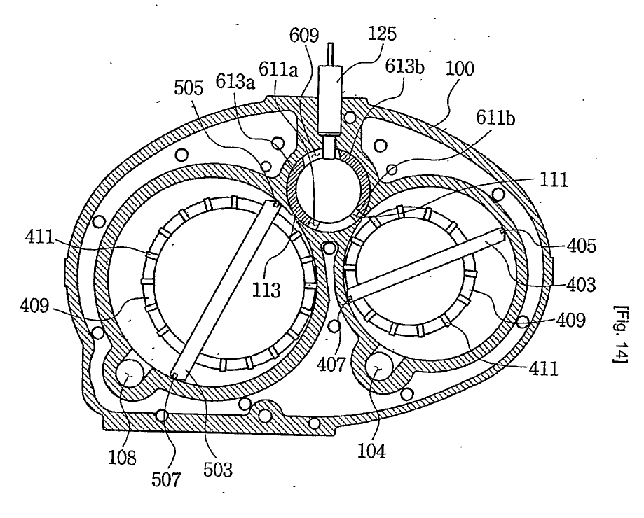

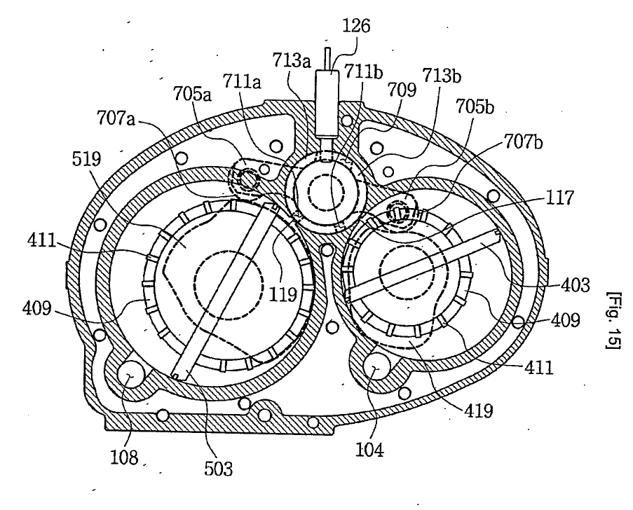

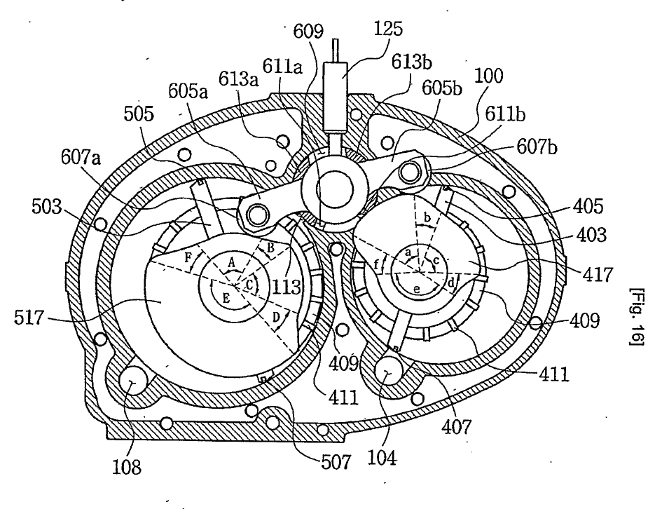

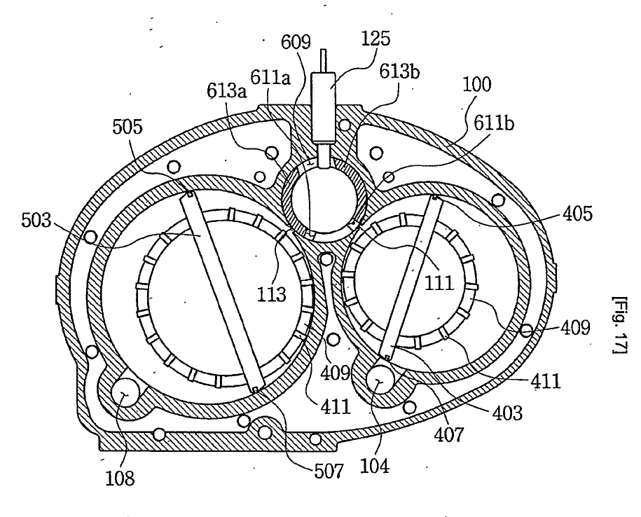

FIG. 1 is an exploded perspective view of a rotary engine, according to an embodiment of the present invention. FIG. 2 is a perspective view of an engine body 100 of the rotary engine. FIG. 3 is a sectional view taken along the line A-A′ of FIG. 2. FIG. 4 is a sectional view taken along the line B-B′ of FIG. 2. FIG. 5 is a perspective view showing a compression rotor 400 of the rotary engine. FIG. 6 is a perspective view showing an output rotor 500 of the rotary engine. FIG. 7 is a perspective view showing a valve 600 of the rotary engine. FIG. 8 is a front view showing the valve 600 of the rotary engine. FIG. 9 is a partially broken perspective view showing a valve body 601 of the valve 600. FIG. 10 is an assembled perspective view showing a main shaft (power transmission shaft) side of the rotary engine. FIG. 11 is a front view showing the rotary engine of FIG. 10. FIG. 12 is an assembled perspective view showing the opposite side of FIG. 10. FIGS. 13 through 33 are sectional views showing the operation of the rotary engine in stages.

Referring to FIG. 1, the rotary engine of the present invention includes the engine body 100, the compression rotor 400, the output rotor 500, to which a main shaft 521 is mounted, a pair of valves 600 and 700, two covers 200 and 300 and a medial gear 490. Preferably, sealing plates 160 and 180 are interposed between the engine body 100 and the two covers 200 and 300, thus enhancing the sealing ability of the covers 200 and 300.

Referring to FIGS. 2 through 4, a compression chamber 101, an output chamber 105 and first and second combustion chambers 109 and 115 are defined in the engine body 100. The two combustion chambers 109 and 115 are symmetrical based on a medial cross-section of the engine body 100, and ignition devices 121 and 123 are provided in the respective combustion chambers 109 and 115. The compression rotor 400, the output rotor 500 and the valves 600 and 700 are respectively inserted into the compression chamber 101, the output chamber 105 and the first and second combustion chambers 109 and 115, which are formed so as to be parallel to each other in the engine body 100 and to be rotatable while maintaining airtightness with the inner surfaces of the chambers. To ensure rotation of the sliding vanes 403 and 503 despite the compression rotor 400 and the output rotor 500 being eccentric, each of the compression chamber 101 and the output chamber 105 has a slightly distorted elliptical cylinder shape, in which the distance from a horizontal line passing through the central axis to the inner surface of the chamber 101, 105 on the eccentric side is greater than on the other side. The degree of distortion of each chamber is changed depending on the degree of eccentricity of the rotor shaft. As an example, in the attached drawings, each chamber has an almost perfectly cylindrical shape. Each of the first and second combustion chambers 109 and 115 has a perfectly cylindrical shape. At a predetermined position below the compression chamber 101, an intake hole 103, through which air or a fuel/air mixture is drawn, is formed through the front and rear surfaces of the engine body 100. The opposite ends of the intake hole 103 are open to the compression chamber 101. Furthermore, a discharge hole 103 is formed through the front and rear surfaces of the engine body 100 below the output chamber 105 at a predetermined position corresponding to the intake hole 103. The opposite ends of the discharge hole 103 are open to the output chamber 105.

One special feature of the present invention resides in the fact that the first and second combustion chambers 109 and 115 are formed in a single engine body 100. This is necessary in order to realize continuous rotation of the output rotor 500 without a change in output torque, and, as well, makes it possible for each combustion chamber to conduct one combustion process when the output rotor rotates one time. In other words, the above-mentioned feature of the present invention makes it possible for two combustion processes to be alternately conducted when the output rotor rotates one time, thus minimizing noise and vibration, and maximizing the output of power.

Another special feature of the present invention resides in the fact that the present invention has a first intake gate 111, which communicates the first combustion chamber 109 with the compression chamber 101, a second intake gate 117, which communicates the second combustion chamber 115 with the compression chamber 101, a first discharge gate 113, which communicates the first combustion chamber 109 with the output chamber 105, and a second discharge gate 119, which communicates the second combustion chamber 115 with the output chamber 105. As shown in FIGS. 13 through 15, in the case that the first and second combustion chamber 109 and 115 are defined above the area between the compression chamber 101 and the output chamber 105, it is preferable that the intake gates 111 and 117 and the discharge gates 113 and 119 be formed at lower positions of the combustion chambers 109 and 115 such that they are inclined towards the compression chamber 101 and the output chamber 105.

Air or fuel/air mixture, which has been compressed in the compression chamber 101, is supplied to and ignited in the first and second combustion chambers 109 and 115 through the first and second intake gates 111 and 117. High-pressure combustion gas, which is generated after ignition, is supplied into the output chamber 105 through the first and second discharge gates 113 and 119.

The valves 600 and 700 are installed in the respective first and second combustion chambers 109 and 115 to alternately open the intake gates 111 and 117 and the discharge gate 113 and 119. The two valves 600 and 700 have the same construction and function. The first valve 600 is shown in FIGS. 7 through 9, but the drawings and explanation related to the first valve 600 also apply to the second valve 700.

Referring to FIGS. 7 through 9, the first valve 600 includes the cylindrical valve body 601, having an appropriate outer diameter such that it is in close contact with the inner surface of the first combustion chamber 109. Passages 611a, 611b and 611c are formed at a lower position through a wall of the valve body 601, so that, when the valve body 601 rotates, the first intake gate 111 and the first discharge gate 113 alternately communicate with each other through the passages 611a, 611b and 611c. An ignition device receiving hole 609 is formed through the valve body 601 at a position opposite the passages 611a, 611b and 611c.

Furthermore, a valve shaft 615, having a bearing 603 thereon, longitudinally extends from an end of the valve body 601. Valve arms 605a and 605b, which are disposed outside the bearing 603, perpendicularly extend from the valve shaft 615 in opposite directions. Rollers 607a and 607b are provided at respective ends of the valve arms 605a and 605b. Thus, the rollers 607a and 607b respectively ride a main cam 517 of the output rotor 500 and a subsidiary cam 417 of the compression rotor 400, thereby the valve body 601 is reciprocally rotated within a predetermined angular range. This operation will be described later herein.

Referring to FIGS. 13 and 27, the distance between each intake gate 111, 117 and each discharge gate 113, 119 is determined such that, when each intake passage 611b, 711b, which is formed in one end of the passage of each valve body, communicates with the intake gate 111, 117, each discharge gate 113, 119 is closed by each discharge passage blocking part 613a, 713a, and, when each discharge passage 611a, 711a, which is formed in the opposite end of the passage of each valve body, communicates with each discharge gate 113, 119, the intake gate 111, 117 is closed by each intake passage blocking part 613b, 713b.

Referring to FIG. 6, the output rotor 500 includes the sliding vane 503, which is inserted into the output chamber of the engine body 100, so that, when high-pressure combustion gas is discharged from the combustion chambers 109 and 115 through the discharge gates 113 and 119, the sliding vane 503 is rotated by the pressure of the discharged gas while maintaining airtightness with the inner surface of the output chamber 105. For this, the output rotor 500 is installed such that a rotor shaft 501 of the output rotor 500 is eccentric from the central axis of the output chamber 105 towards the compression chamber 101 or the discharge gates 113 and 119. The sliding vane 503 crosses the central axis of the rotor shaft 501 and is disposed so as to be slidable in a radial direction of the rotor shaft 501. As described above, to correspond to the eccentricity of the output rotor 500, the output chamber 105 has an elliptical cylinder shape in which the distance from a horizontal line passing through the central axis to the inner surface of the output chamber 105 on the eccentric side is greater than on the other side. Sealing members 505 and 507, each being elastic in a radial direction, are provided on respective ends of the sliding vane 503 which contact the inner surface of the output chamber 105. Referring to FIG. 13, when the output rotor 500 rotates, airtightness between the sliding vane 503 and the inner surface of the output chamber 105 must be maintained by the sealing members 505 and 507. Also, airtightness between the discharge gates 113 and 119 and a discharge hole 107 of the output chamber 105 must always be ensured. To achieve the above-mentioned criterion, the output rotor 500 includes a plurality of discharge hole sealing pieces 511, each of which extends a predetermined length in a longitudinal direction on an outer surface of a cylindrical body, which is coaxial with the rotor shaft 501 and has a diameter less than the width of the sliding vane 503. Each discharge hole sealing piece 511 is constructed such that it is radially elastically operated. An elastic connection member 529 is provided at a medial position in each discharge hole sealing piece 511, such that the discharge hole sealing piece 511 also has axial elasticity. A spacer 509 is provided between adjacent discharge hole sealing pieces 511 to maintain the distance between them constant. Furthermore, it is preferable that a sealing piece compression hole 527 be formed in each spacer 509 and be connected to the lower end of each discharge hole sealing piece 511, so that compressed gas is supplied to the lower end of the discharge hole sealing piece 511 through the sealing piece compression hole 527. The compressed gas, which is supplied to the lower end of the discharge hole sealing piece 511, presses the discharge hole sealing piece 511 outwards in a radial direction, thus making it possible to maintain airtightness regardless of the pressure in the output chamber 105. Preferably, cover side sealing pieces 513, each having axial elasticity, are provided on opposite ends of each spacer 509 and are in close contact with the inner surfaces of the covers 200 and 300 or the sealing plates 160 and 180, thus preventing pressure leakage. As well, it is preferable that the lower end of each cover side sealing piece 513 be connected to each sealing piece compression hole 527 such that compressed gas is supplied to the lower ends of the cover side sealing pieces 513.

The first main cam 517 and a second main cam 519, along which the rollers of the valves 600 and 700 move to rotate the valve bodies in the combustion chambers, are provided on respective opposite ends of the rotor shaft 501 of the output rotor 500. An output rotor gear 515 is provided on the rotor shaft 501 inside the second main cam 519. Bearings 523 and 525 are provided on the rotor shaft 501 both inside the first main cam 517 and inside the output rotor gear 515.

Meanwhile, a further special feature of the present invention resides in that the two main cams 517 and 519, which are provided on the rotor shaft 501 of the output rotor 500 so as to correspond to the two combustion chambers 109 and 115, are symmetrical with each other based on the central axis of the rotor shaft 501. Then, the passages, which are formed in the first valve 600, and the passages, which are formed in the second valve 700, are symmetrically disposed, so that explosion processes are alternately conducted in the first and second combustion chambers 109 and 115 every rotation of the output rotor.

The construction of the compression rotor 400 of FIG. 3, other than the cams 417 and 419 being configured such that there are differences in phase of 90 degrees between the cams 417 and 419 and the main cams 517 and 519 with respective to the valve shaft 615 and 715, is equal to that of the output rotor 500.

As shown in FIG. 3, the compression rotor 400 draws air or fuel/air mixture through the intake hole 103 using the sliding vane 403, which is provided in the compression chamber 101 of the engine body 100 and rotates while maintaining airtightness between it and the inner surface of the compression chamber 101. Consecutively, the compression rotor 400 compresses and alternately supplies the drawn air or mixture using the sliding vane 403 into the first and second combustion chambers 109 and 115 through the first and second intake gates 111 and 117. For this, the compression rotor 400 is installed such that a rotor shaft 401 of the compression rotor 400 is eccentric from the central axis of the compression chamber 101 towards the output chamber 105 or the intake gates 111 and 117. The sliding vane 403 crosses the central axis of the rotor shaft 401 and is disposed so as to be slidable in a radial direction of the rotor shaft 401. The sliding vane 403 has a width such that the opposite side ends of the sliding vane 403 diametrically contact the inner surface of the compression chamber 101. Sealing members 405 and 407, each having elasticity in a radial direction, are provided on respective ends of the sliding vane 403 which contact the inner surface of the compression chamber 101. Referring to FIG. 13, when the compression rotor 400 rotates, airtightness between the sliding vane 403 and the inner surface of the compression chamber 101 must be maintained by the sealing members 405 and 407. Also, airtightness between the intake gates 111 and 117 and an intake hole 104 of the compression chamber 105 must always be ensured. To achieve the above-mentioned purpose, the compression rotor 400 includes a plurality of intake hole sealing pieces 411, each of which extends a predetermined length in a longitudinal direction on an outer surface of a cylindrical body, which is coaxial with the rotor shaft 401 and has a diameter less than the width of the sliding vane 403. The intake hole sealing pieces 411 are installed such that they are radially elastic. An elastic connection member 429 is provided at a medial position in each intake hole sealing piece 411, such that the intake hole sealing piece 411 also has axial elasticity. A spacer 409 is provided between adjacent intake hole sealing pieces s11 to maintain the distance between them constant. Furthermore, it is preferable that a sealing piece compression hole 427 be formed in each spacer 409 and be connected to the lower end of each intake hole sealing piece 411, so that compressed gas is supplied to the lower end of the intake hole sealing piece 411 through the sealing piece compression hole 427. The compressed gas, which is supplied to the lower end of the intake hole sealing piece 411, presses the intake hole sealing piece 411 outwards in a radial direction, thus making it possible to maintain airtightness regardless of the pressure in the compression chamber 101. Preferably, cover side sealing pieces 413, each having axial elasticity, are provided on opposite ends of each spacer 409 and are in close contact with the inner surfaces of the covers 200 and 300 or the sealing plates 160 and 180, thus preventing pressure leakage. As well, it is preferable that the lower end of each cover side sealing piece 413 be connected to each sealing piece compression hole 427 such that compressed gas is supplied to the lower ends of the cover side sealing pieces 413.

As described above, the first main cam 517 and a second main cam 519, along which the rollers of the valves 600 and 700 move so as to rotate the valve bodies in the combustion chambers, are provided on respective opposite ends of the rotor shaft 501 of the output rotor 500. The output rotor gear 515 is provided on the rotor shaft 501 inside the second main cam 519. The bearings 523 and 525 are provided on the rotor shaft 501 both inside the first main cam 517 and inside the output rotor gear 515.

In a construction similar to that of the output rotor 500, first and second subsidiary cams 417 and 419 are provided on respective opposite ends of the rotor shaft of the compression rotor 400 and guide the respective compression rotor side rollers 607b and 707b of the valves 600 and 700, such that each compression rotor side roller 607b, 707b and each output rotor side roller 607a, 707a of the valves 600 and 700 are point-symmetrical with respective to the valve shaft. Furthermore, a compression rotor gear 415 is provided inside the second subsidiary cam 419, and bearings 423 and 425 are provided on the rotor shaft 401 both inside the first subsidiary cam 417 and inside the compression rotor gear 415.

Referring to FIG. 10, in the rotary engine of the present invention, the valves 600 and 700 are installed in the two respective combustion chambers 109 and 115, which use the compression rotor 400 and the output rotor 500 in common. Furthermore, the main shaft 521 is mounted to the output rotor 500 to transmit rotating force, generated from the engine, to the outside.

Referring to FIGS. 11 and 12, the pitch and the number of teeth of the gear 415, which is provided in the compression rotor 400, are equal to those of the gear 515, which is provided in the output rotor 500. The medial gear 490, which is an idle gear, is interposed between the two gears 415 and 515, so that the two gears 415 and 515 rotate in the same direction and the compression rotor 400 rotates in conjunction with the rotation of the output rotor 500. Furthermore, the valve arms 605a, 605b, 705a and 705b of the valves 600 and 700 extend to positions above the rotating shafts of the compression rotor 400 and the output shaft 500. The rollers 607a, 607b, 707a and 707b provided on the ends of the valve arms 605a, 605b, 705a and 705b ride the main cams 517 and 519 of the output rotor 500 and the subsidiary cams 417 and 419 of the compression rotor 400, so that the valves 600 and 700 are rotated within angular ranges depending on the rotation of the output rotor 500 and the compression rotor 400.

Returning to FIG. 1, an intake hole 207 is formed in the first cover 200 of the two covers 200 and 300. The intake hole 207 of the first cover 200 communicates both with the intake hole 103, which is formed in the engine body 100, and with an intake port 211, which is formed outside the engine. Furthermore, a discharge hole 209 is formed in the first cover 200 having the intake hole 207. The discharge hole 209 of the first cover 200 communicates both with the discharge hole 107, which is formed in the engine body 100, and with a discharge port 213, which is formed outside the engine.

The operation of the rotary engine of the present invention having the above-mentioned construction will be described herein below with reference to FIGS. 13 through 33.

FIGS. 13 through 33 are simplified sectional views showing the rotary engine with some parts removed in order to illustrate the operational relationship among the valves 600 and 700 installed in the combustion chambers 109 and 115, the main cams 517 and 519 of the output rotor 500, the subsidiary cams 417 and 419 of the compression rotor 400, the sliding vane 503 of the output rotor 500 and the sliding vane 403 of the compression rotor 400.

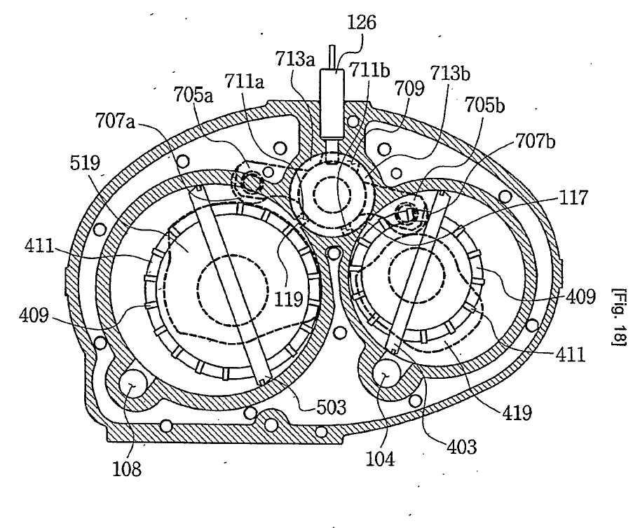

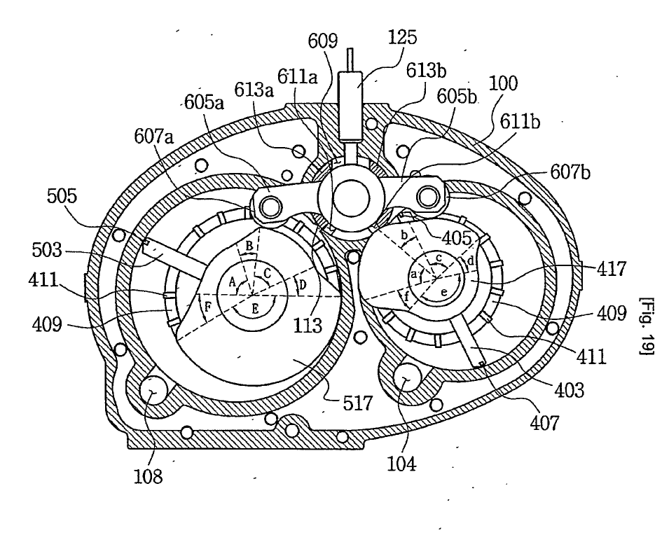

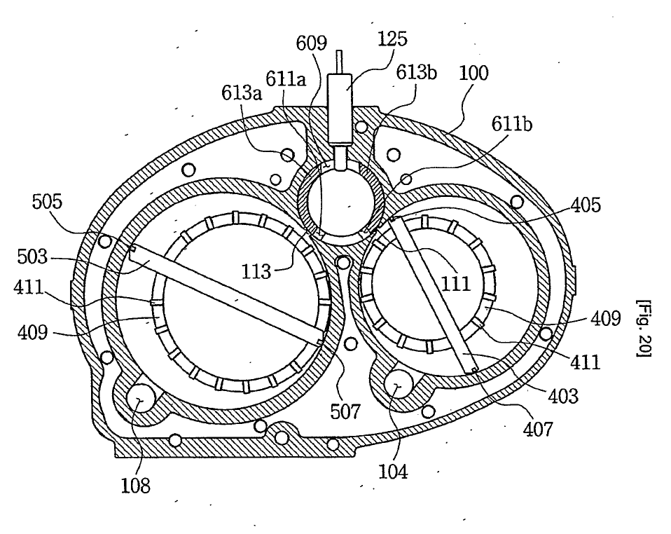

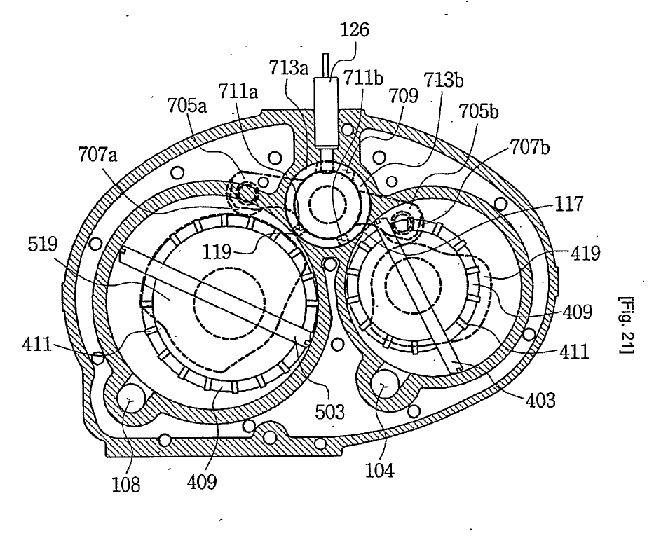

FIGS. 13 and 14 shows the operational relationship among the first valve 600 installed in the first combustion chamber 109, the first main cam 517 of the output rotor 500, the first subsidiary cam 417 of the compression rotor 400, the sliding vane 503 of the output rotor 500 and the sliding vane 403 of the compression rotor 400. FIG. 15 shows the operational relationship among the second valve 700 (shown as the dotted line) installed in the second combustion chamber 115, the second main cam 519 (shown as the dotted line) of the output rotor, the second subsidiary cam 419 (shown as the dotted line) of the compression rotor 400, the sliding vane 503 of the output rotor 500 and the sliding vane 403 of the compression rotor 400, at the same time as the state of FIGS. 13 and 14. FIGS. 16, 19, 22, 25, 28 and 31 are views corresponding to FIG. 13. FIGS. 17, 20, 23, 26, 29 and 31 are views corresponding to FIG. 14. FIGS. 18, 21, 24, 27, 30 and 33 are views corresponding to FIG. 15. In FIGS. 13 through 33, the reference numerals 125 and 126 denote ignition devices. In the case that gas to be supplied into the compression chamber 101 is a fuel/air mixture, ignition plugs are used as the ignition devices 125 and 126. In the case that gas to be supplied into the compression chamber 101 is air, fuel injectors are used as the ignition devices 125 and 126. Each ignition device receiving hole 609, 709 has a size sufficient to prevent the ignition device 125, 126 from interfering with the rotation of the valve body.

Referring to FIG. 13, it will be appreciated that each of the first main cam 517 and the first subsidiary cam 417 is sectioned into six sections according to the distance from the central shaft to the outer surface. In detail, they are sectioned into the sections A, a, C, c, E and e, in which the valve body does not rotate, and into the sections B, b, D, d, F and f, in which the valve body rotates. In the following description, the sections A and a denote a compression process, the sections C and c denote an explosion process and the sections E and e denote an output process. Here, particularly, the duration of the sum of the sections A and a (the compression process), B and b (a valve rotation process) and C and c (the explosion process) is equal to the duration of the sections E and e (the output process). In each of the sections A and a, C and c, and E and e, because the distance from the central shaft to the outer surface of the cam is constant, the valve body does not rotate. In each of the sections B and b, D and d, and F and f, because the distance from the central shaft to the outer surface of the cam is variable, the valve body is rotated. In the section A of the first main cam 517, the distance from the central shaft to the outer surface thereof is lowest and constant. In the section a of the first subsidiary cam 417 corresponding to the section A, the distance from the central shaft to the outer surface thereof is highest and constant. Therefore, while the rollers 607a and 607b respectively ride the first main cam 517 and the first subsidiary cam 417 in the sections A and a, the valve arms 605a and 605b maintain the state of being tilted towards the first main cam 517. Thus, the body of the first valve 600 maintains the state of being rotated towards the compression chamber 101, so that the intake passage 611b of the first valve body communicates with the first intake gate 111, and, simultaneously, the discharge blocking part 613a of the first valve body closes the first discharge gate 113.

FIG. 14 shows the positions of the sliding vane 503 of the output rotor 500 and the sliding vane 403 of the compression rotor 400 when the sections A and a of the first main cam 517 and the first subsidiary cam 417 begin. As shown in FIG. 14, the lower end of the sliding vane 403 of the compression rotor 400 is at a position occupied before passing through the intake hole 104. While the first main cam 517 and the first subsidiary cam 417 pass through the sections A and a, fuel/air mixture or air is drawn through the intake hole 104, and fuel/air mixture or air is compressed and supplied into the first combustion chamber 109 via the first intake gate 111 and the intake passage 611b of the first valve. As such, the sections A and a correspond to a compression process.

In the compression process (the sections A and a), fuel/air mixture or air is supplied into the first combustion chamber by the compression rotor 400, but combustion gas is not output to the output chamber from the first combustion chamber. Therefore, while the compression process is conducted in the first combustion chamber, an output process should be conducted in the second combustion chamber. FIG. 15 illustrates that, when the compression process in the first combustion chamber begins, an output process in the second combustion chamber begins. As shown in FIG. 15, in the section E of the second main cam 519, the distance from the central shaft to the outer surface thereof is highest and constant. In the section e of the second subsidiary cam 419 corresponding to the section E of the second main cam 517, the distance from the central shaft to the outer surface thereof is lowest and constant. Therefore, when the rollers 707a and 707b ride the cams 519 and 419 in the sections E and e, the valve arms 705a and 705b are tilted towards the second subsidiary cam 419. Thus, the body of the second valve 700 is rotated towards the output chamber 105, so that the discharge passage 711a of the second valve body communicates with the second discharge gate 119, and, simultaneously, the intake blocking part 713b of the second valve body closes the second intake gate 117. As such, the output process is conducted in the second combustion chamber.

FIG. 16 shows the state of the rotary engine at the time when the sections A and a of the first main cam 517 and the first subsidiary cam 417 is finished. FIG. 17 shows the positions of the sliding vane 403 of the compression rotor 400 and the sliding vane 503 of the output rotor 500 in the state of FIG. 16. Referring to FIG. 18, it is appreciated that, even after the compression process of the first combustion chamber is finished, the output process of the second combustion chamber continues. The reason is that the sections E and e (the output processes) of the main cams 517 and 519 and the subsidiary cams 417 and 419 are longer than the sections A and a (the compression processes) or the sections C and c (the explosion processes). As described above, the duration of the sum of the sections A and a (the compression process), the sections B and b (the valve rotation process) and the sections C and c (the explosion process) of each of the first and second main cams 517 and 519 is equal to the duration of each of the sections E and e (the output process). Therefore, the output process of the second combustion chamber 115 continues from the time that the compression process of the first combustion chamber 109 begins until the time that explosion process of the first combustion chamber 109 finishes.

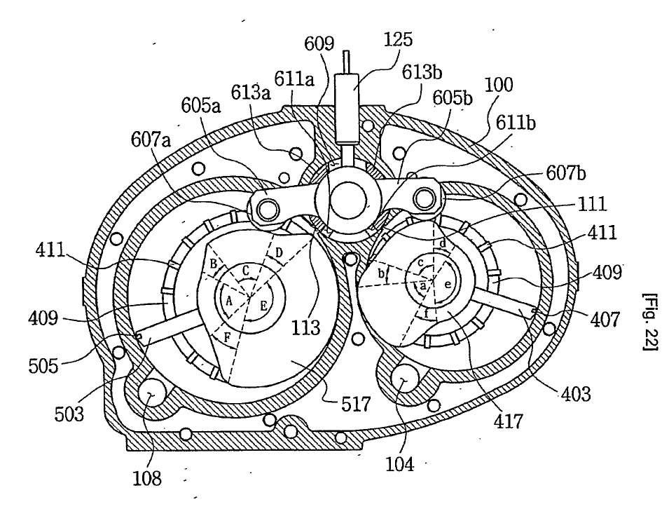

Referring to FIG. 19, after the compression process (the sections A and a) has finished, the rollers 607a and 607b ride the cams during the sections B and b and rotate the valve body such that the passage of the valve body faces the lower portion of the first combustion chamber. As a result, as shown in FIG. 20, the first intake gate 111 and the first discharge gate 113 are respectively closed by the intake blocking part 613b and the discharge blocking part 613a. In the sections C and c, the process takes place while the first combustion chamber is closed. At a desired position of the sections C and c, ignition is conducted by the ignition device. For example, when the engine starts, ignition is preferably conducted at the time when the sections C and c end. As the revolutions of the engine are increased during acceleration, the time of ignition is gradually moved forward. As such, if the time of ignition is moved forward during acceleration, sufficient time to realize complete combustion of fuel before high-pressure combustion gas is discharged into the output chamber can be obtained. This method makes it possible to realize complete combustion of fuel and to maximize the output of power.

As such, yet another special feature of the present invention is that the time of ignition is adjusted in each combustion chamber so that sufficient time to conduct the explosion process is obtained, thus realizing the complete combustion of fuel and maximizing the efficiency of the engine. Sufficient time for the explosion process can be obtained in such a manner only by the structure in which the two combustion chambers communicate both with the single compression chamber and with the single output chamber.

Referring to FIG. 19, in the section C of the first main cam 517, the distance from the central shaft to the outer surface thereof is intermediate and constant. In the section c of the first subsidiary cam 417 corresponding to the section C, the distance from the central shaft to the outer surface thereof is also intermediate and constant. Therefore, while the rollers 607a and 607b respectively ride the first main cam 517 and the first subsidiary cam 417 in the sections C and c, the valve arms 605a and 605b maintain an almost horizontal state. Furthermore, the passages 611a, 611b and 611c of the first valve face the center of the lower portion of the combustion chamber, so that the first intake gate 111 is closed by the intake blocking part 613b of the first valve body, and the first discharge gate 113 is closed by the discharge blocking part 613a of the first valve body.

FIG. 20 shows the positions of the sliding vane 503 of the output rotor 500 and the sliding vane 403 of the compression rotor 400 when the sections C and c of the first main cam 517 and the first subsidiary cam 417 begin.

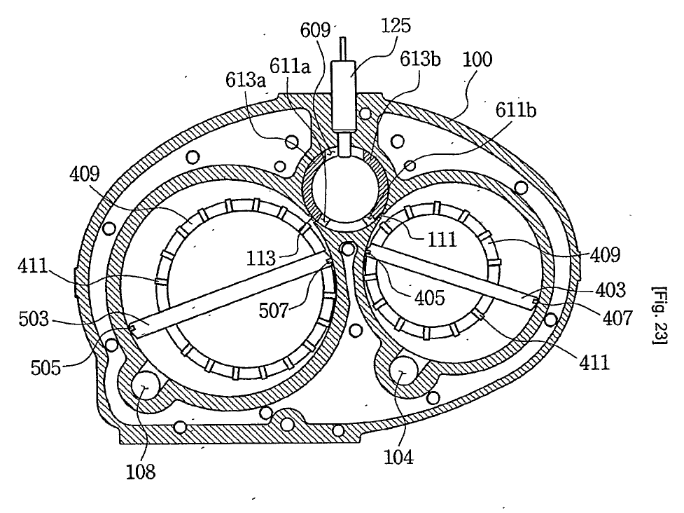

Even during the explosion process (the sections C and c) of the first combustion chamber, no combustion gas is discharged from the first combustion chamber to the output chamber. Therefore, while the explosion process is conducted in the first combustion chamber, the output process must be conducted in the second combustion chamber. FIG. 21 illustrates that, even when the explosion process of the first combustion chamber begins, the output process of the second combustion chamber continues.

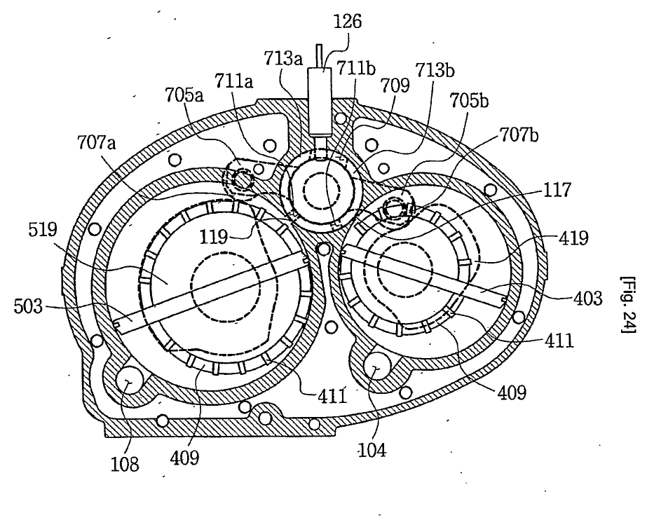

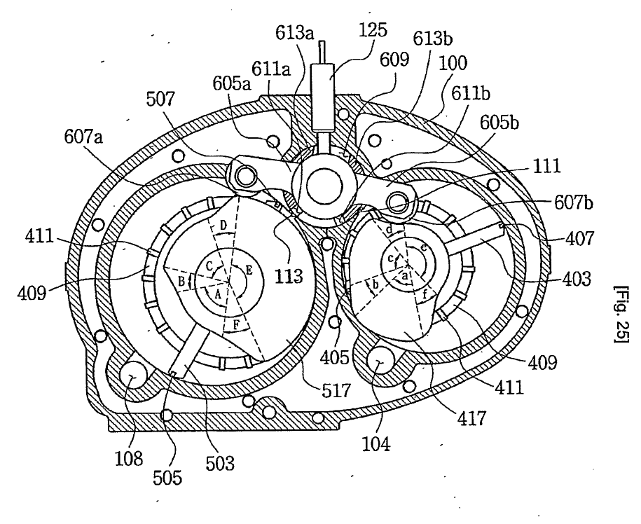

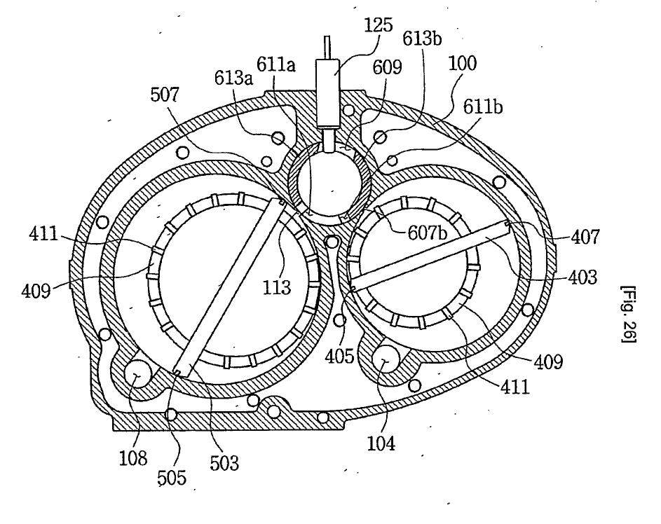

FIG. 22 shows the state of the rotary engine when the sections C and c of the first main cam 517 and the first subsidiary cam 417 are finished. FIG. 23 shows the positions of the sliding vane 403 of the compression rotor 400 and the sliding vane 503 of the output rotor 500 in the state of FIG. 22. Referring to FIG. 24, it is appreciated that, when the explosion process of the first combustion chamber is finished, the output process of the second combustion chamber is also finished. That is, at this time, the source of propulsion of the output rotor changes from the second combustion chamber to the first combustion chamber.

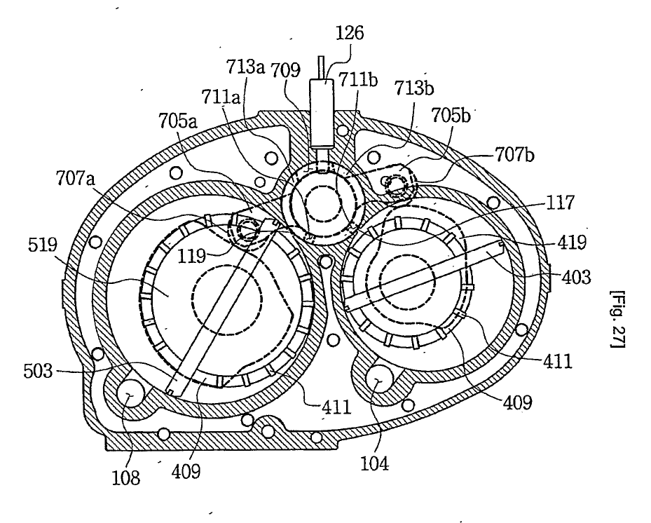

Referring to FIG. 25, while the rollers 607a and 607b respectively ride the first main cam 517 and the first subsidiary cam 417 in the sections D and d, the passages of the valve body are rotated towards the first discharge gate 113 such that the first discharge gate 113 communicates with the discharge passage 611a of the valve body and the first intake gate 111 is closed by the intake blocking part 613b.

At the moment that the first discharge gate 113 communicates with the discharge passage 611a of the valve body, the high-pressure combustion gas, which has been generated in the explosion process, is forcibly discharged into the output chamber 105, thus rotating the output rotor 500.

In the section E of the first main cam 517, the distance from the central shaft to the outer surface thereof is highest and constant. In the section e of the first subsidiary cam 417 corresponding to the section E, the distance from the central shaft to the outer surface thereof is lowest and constant. Therefore, while the rollers 607a and 607b respectively ride the first main cam 517 and the first subsidiary cam 417 in the sections E and e, the valve arms 605a and 605b maintain the state of being tilted towards the first subsidiary cam 417. Thus, the body of the first valve 600 maintains the state of being rotated towards the output chamber 105, so that the discharge passage 611a of the first valve body communicates with the first discharge gate 113, and, simultaneously, the intake blocking part 613b of the first valve body closes the first intake gate 111.

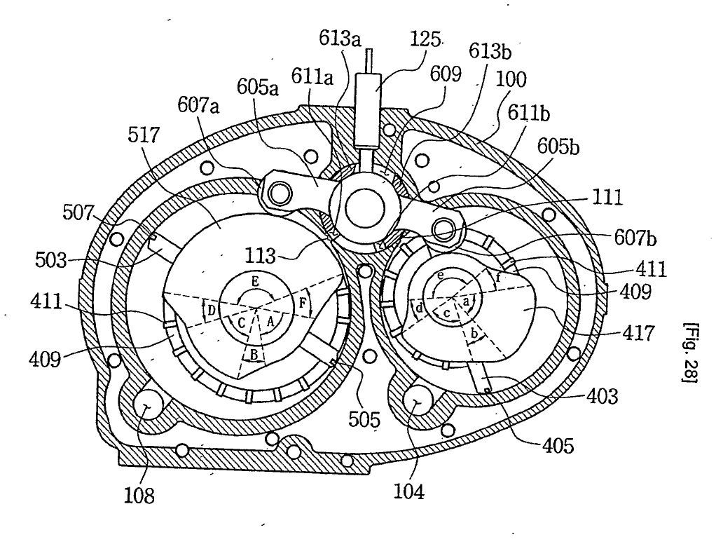

FIG. 26 shows the positions of the sliding vane 503 of the output rotor 500 and the sliding vane 403 of the compression rotor 400 when the sections E and e of the first main cam 517 and the first subsidiary cam 417 begin. As shown in FIG. 26, the upper end of the sliding vane 503 of the output rotor 500 is at a position occupied just after passing through the first discharge gate 113. While the first main cam 517 and the first subsidiary cam 417 pass through the sections E and e, the discharge hole 108 is isolated from the first discharge gate 113 by the sliding vane 503. Until the sections E and e end, high-pressure compressed gas, which has been generated in the first combustion chamber, is discharged to the output chamber. Therefore, the sections E and e correspond to the output process.

Referring to FIG. 27, when the output process (the sections E and e) of the first combustion chamber begins, the intake process in the second combustion chamber begins. Therefore, while the output process (the sections E and e) is conducted in the first combustion chamber, no combustion gas is discharged from the second combustion chamber to the output chamber.

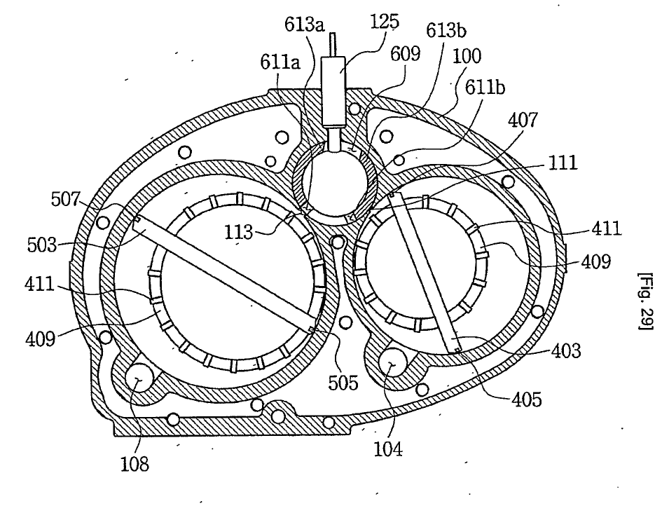

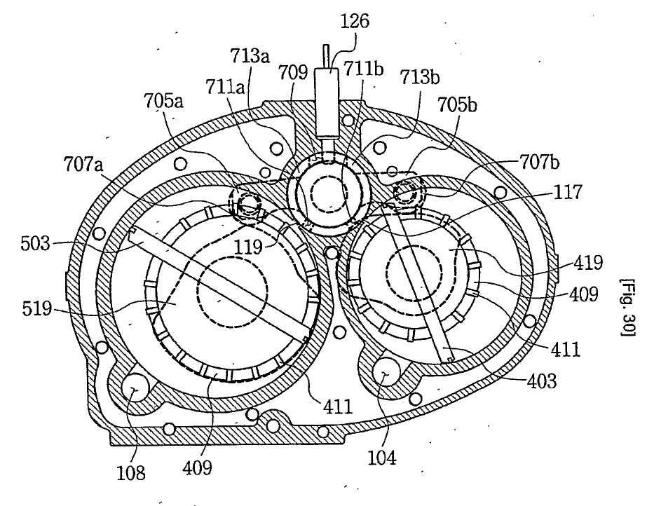

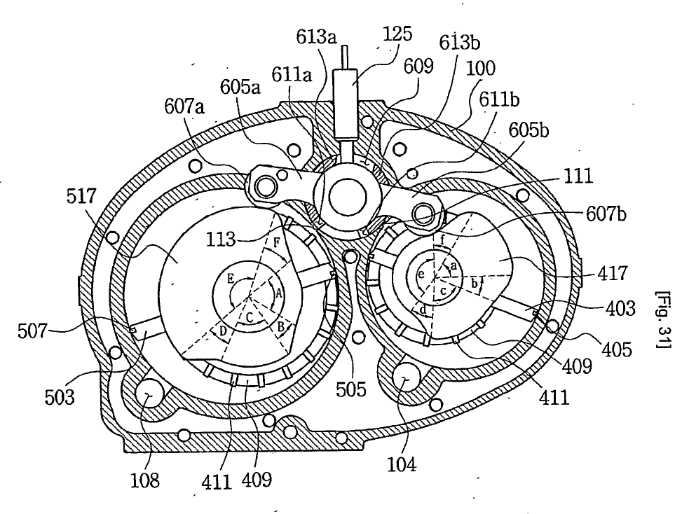

FIG. 30 shows the state of the rotary engine when the explosion process of the second combustion chamber begins. FIGS. 28 and 29 show the state of the first combustion chamber at that time and illustrate that, even when the explosion process of the second combustion chamber begins, the output process (the sections E and e) of the first combustion chamber continues.

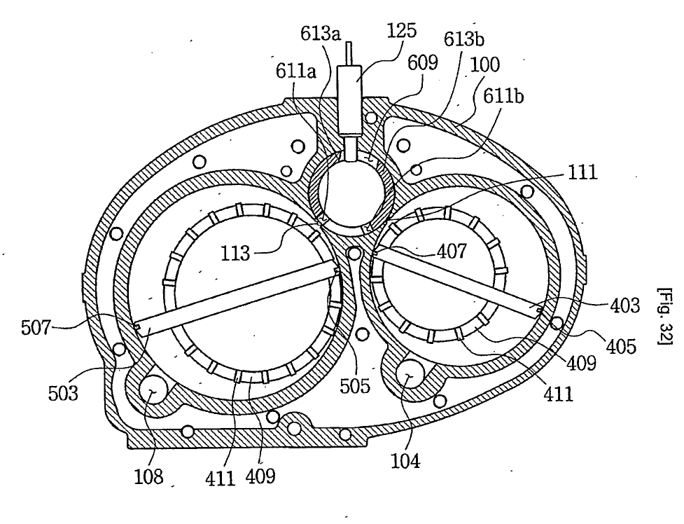

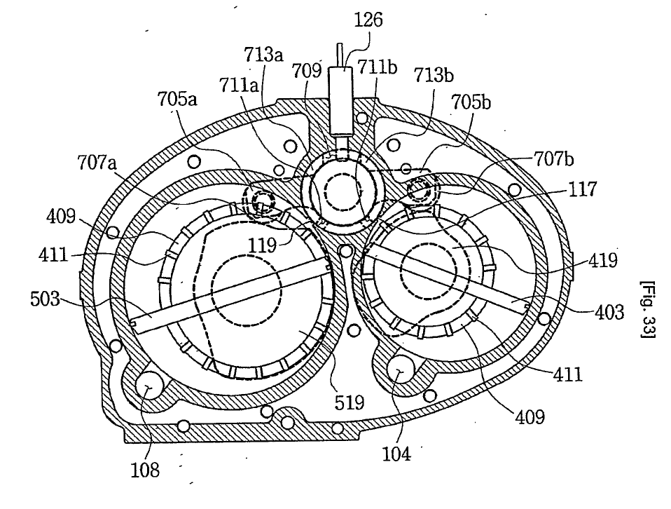

FIGS. 31 and 32 show the state of the rotary engine when the output process (the sections E and e) of the first combustion chamber is finished. FIG. 33 shows the state of the second combustion chamber when the first combustion chamber is in the state of FIGS. 31 and 32.

As shown in FIG. 31 through 33, when the output process (the sections E and e) of the first combustion chamber is finished, the explosion process of the second combustion chamber is also finished, and a new output process is ready to start.

Subsequently, the rotary engine is returned to the state of FIGS. 13 through 15, and the above-mentioned processes are repeated, thereby the output rotor generates rotating force.

### Industrial Applicability

As described above, the present invention provides a rotary engine, in which complete combustion of fuel is realized, and explosive combustion power is transmitted to an output shaft without power loss, thus maximizing the efficiency of the engine, and which makes it possible to minimize vibration, noise and pressure leakage. Furthermore, because complete combustion is realized, there is an advantage in that automobile exhaust fumes, which are principal factors of air pollution, are minimized.

Although the preferred embodiment of the present invention has been disclosed for illustrative purposes, the scope of the present invention is not limited to the preferred embodiment. Furthermore, those skilled in the art will appreciate that various modifications, additions and substitutions are possible, without departing from the scope and spirit of the invention as disclosed in the accompanying claims. Therefore, it must be appreciated that the scope of the present invention is defined by the accompanying claims.

1. A rotary engine, comprising:
an engine body, comprising: a cylindrical compression chamber having at a predetermined position thereof an intake hole, through which fuel/air mixture or air is drawn into the compression chamber; an output chamber formed through the engine body in a direction parallel to the compression chamber and having at a predetermined position thereof a discharge hole, through which combustion gas is discharged; and a combustion chamber formed between the compression chamber and the output chamber in a direction parallel both to the compression chamber and to the output chamber and divided into two cylindrical bores, which are symmetrical to each other, and each of which communicates with the compression chamber through an intake gate and communicates with the output chamber through a discharge gate;
a compression rotor eccentrically provided in the compression chamber of the engine body and rotating such that fuel/air mixture or air is drawn into the compression chamber through the intake hole, compressed, and supplied into the combustion chamber through the intake gates;
an ignition device provided in the combustion chamber of the engine body to ignite and explode the mixture or air compressed and supplied by the compression rotor;
an output rotor eccentrically provided in the output chamber of the engine body and rotated using propulsive force generated by the combustion gas supplied from the compression chamber through the discharge gates;
valves provided in respective bores of the combustion chamber and controlling the intake gates and the discharge gates such that a compression process, a combustion process and an output process are sequentially conducted depending on rotational positions of the compression rotor and the output rotor;
synchronizing means to rotate the compression rotor in conjunction with rotation of the output rotor; and
axial sealing means for sealing the compression chamber, the combustion chamber and the output chamber of the engine body.

2. The rotary engine according to claim 1, wherein the compression rotor comprises:
a rotor shaft disposed at an eccentric position towards the output chamber relative to a central axis of the compression chamber;
a sliding vane crossing a central axis of the rotor shaft and disposed so as to be slidable in a radial direction of the rotor shaft, the sliding vane having a width such that opposite side ends of the sliding vane diametrically contact an inner surface of the compression chamber, with a sealing member, having elasticity in a radial direction, provided on each of the side ends of the sliding vane which contact the inner surface of the compression chamber;
a plurality of intake hole sealing pieces axially provided on a cylindrical surface, which is coaxial with the rotor shaft and has a diameter less than the width of the sliding vane, each intake hole sealing piece having radial and axial elasticity; and a spacer provided between adjacent intake hole sealing pieces such that the intake hole sealing pieces maintain a predetermined distance therebetween.

3. The rotary engine according to claim 1, wherein the output rotor comprises: a rotor shaft disposed at an eccentric position towards the compression chamber relative to a central axis of the output chamber;
a sliding vane crossing a central axis of the rotor shaft and disposed so as to be slidable in a radial direction of the rotor shaft, the sliding vane having a width such that opposite side ends of the sliding vane diametrically contact an inner surface of the output chamber, with a sealing member, having elasticity in a radial direction, provided on each of the side ends of the sliding vane which contact the inner surface of the output chamber;
a plurality of intake hole sealing pieces axially provided on a cylindrical surface, which is coaxial with the rotor shaft and has a diameter less than the width of the sliding vane, each intake hole sealing piece having radial and axial elasticity; and a spacer provided between adjacent intake hole sealing pieces such that the intake hole sealing pieces maintain a predetermined distance therebetween.

4. The rotary engine according to claim 1, wherein each of the valves comprises: a cylindrical valve body having a predetermined outer diameter such that an outer surface of the valve body contacts an inner surface of the related bore of the combustion chamber, with a passage formed through the valve body so that, when the valve body is rotated, the passage selectively communicates with the intake gate or with the discharge gate, and with the ignition device inserted into the valve body at a position opposite the passage; a valve shaft longitudinally extending from a predetermined position of the valve body; valve arms symmetrically provided on an end of the valve shaft in diametrically opposite directions; and a roller provided on an end of each of the valve arms, and
the rotary engine further comprising:
main cams symmetrically provided on respective opposite ends of the rotor shaft of the output rotor at positions corresponding to the related rollers of the valves, so that the rollers ride the respective main cams, rotations of the valve bodies thereby being controlled by the related main cams every cycle of the output rotor such that the rotations of the valve bodies correspond to a rotational angle of the sliding vane of the output rotor; and
subsidiary cams symmetrically provided on respective opposite ends of the rotor shaft of the compression rotor at positions corresponding to the remaining rollers of the valves, the subsidiary cams guiding the rollers related to the compression rotor, such that the rollers related to the compression rotor and the rollers related to the output rotor are point-symmetrical with respect to a central axis of the valve shaft.

5. The rotary engine according to claim 4, wherein the main cams of the output rotor and the subsidiary cams of the compression rotor are configured such that compression process sections, explosion process sections and output process sections, in which the valve bodies maintain orientations thereof for a predetermined time without rotation, are defined, and the main cams and the subsidiary cams are oriented such that, while the main cam provided on an end of the output rotor and the related subsidiary cam provided on an end of the compression rotor are in the output process sections for a predetermined time, the main cam provided on a remaining end of the output rotor and the related subsidiary cam provided on a remaining end of the compression rotor are maintained in the compression process sections and the explosion process sections, thus a time of ignition is controllable within the explosion process sections, which continues for the predetermined time, depending on revolution speed of the engine, thereby realizing complete combustion of fuel.

6. The rotary engine according to claim 1, wherein, when gas to be supplied into the compression chamber through the intake hole is fuel/air mixture, an ignition plug is used as the ignition device, and, when the gas is air, a fuel injector is used as the ignition device.

7. The rotary engine according to claim 1, wherein the axial sealing means comprises:
two covers, each having bearing seats at predetermined positions corresponding both to the rotor shafts of the compression rotor and the output rotor and to the valve shaft of each of the valves to support the rotor shafts and the valve shafts, the two covers being coupled to respective opposite ends of the engine body to seal open ends of the compression chamber, the combustion chamber, and the output chamber; and
cover sealing plates, having axial elasticity, provided on opposite ends of the spacers of both the compression rotor and the output rotor and being in close contact with inner surfaces of the respective covers.
